(19) United States
(12) Patent Application Publication
(10) Pub. No.: US 2012/0061581 A1
(43) Pub. Date: Mar. 15, 2012

(54) MIXED RESOLUTION AND MULTIPLEXING IMAGING METHOD AND SYSTEM

(76) Inventors: James W. Hugg, Simi Valley, CA (US); Ang Liu, Northridge, CA (US); Douglas J. Wagenaar, Westlake Village, CA (US); Bradley E. Patt, Sherman Oaks, CA (US)

(21) Appl. No.: 13/228,187

(22) Filed: Sep. 8, 2011

Related U.S. Application Data
(60) Provisional application No. 61/381,276, filed on Sep. 9, 2010.

(51) Int. Cl. G21K 1/02; G01T 1/16

(52) U.S. Cl. 250/394; 250/395

(57) ABSTRACT

Embodiments relate to an imaging system that includes a collimator assembly having two or more pinhole apertures therein. In one embodiment, the imaging system is configured so that two or more of the pinhole apertures have different focal lengths. The imaging system further includes a detector assembly configured to generate one or more signals in response to gamma photons that pass through the two or more pinhole apertures. Additional embodiments also relate to methods of changing collimator performance and methods of imaging a volume.

### CROSS-REFERENCE TO RELATED APPLICATION(S)

This application claims priority to and the benefit of U.S. Provisional Application No. 61/381,276, filed Sep. 9, 2010, the entire content of which is expressly incorporated herein by reference.

### FIELD

The invention relates generally to non-invasive imaging such as single photon emission computed tomography (SPECT) imaging. More particularly, the invention relates to imaging systems configured to reconstruct images from projections acquired with a mixture of two or more different spatial imaging resolutions and/or two or more different degrees of multiplexing (projection overlap).

### BACKGROUND

Single photon emission computed tomography (SPECT) is used for a variety of imaging applications, particularly in medical imaging. In general, SPECT systems are imaging systems that are configured to generate an image based upon the interaction of gamma photons (generated by a nuclear decay event) in a gamma-photon detector. In medical and research contexts, these detected gamma photons may be processed to formulate an image of organs or tissues beneath the skin.

To produce an image, one or more detector assemblies may be rotated around a subject. Detector assemblies are typically comprised of various structures working together to receive and process the incoming gamma photons. For instance, the detector assembly may utilize a scintillator assembly (e.g., large sodium iodide scintillator plates) to convert the incoming gamma photons into visible or ultraviolet light photons for detection by an optical sensor. This scintillator assembly may be coupled by a light guide to multiple photomultiplier tubes (PMTs) or other light sensors that convert the light photons from the scintillator assembly into electric signals. In addition to the scintillator assembly-PMT combination, pixilated solid-state direct conversion detectors (e.g., Cadmium-Zinc-Telluride, CZT) may also be used to generate electric signals directly from the impact of the incoming photons. These electric signals can be transferred, converted, and processed by electronic modules in a data acquisition module to facilitate viewing and manipulation by clinicians.

Typically, SPECT systems further include a collimator assembly that may be attached to the front of the gamma-ray detector. In general, the collimator assembly is designed to absorb photons such that only photons traveling in certain directions are allowed to impact the detector assembly. In certain instances, pinhole-aperture collimators may be used. Pinhole-aperture collimators are generally collimators with one or more small pinhole apertures therein. Photons passing through these pinhole apertures generally project an inverted image of at least a portion of the source onto the detector assembly.

In general, the system resolution and geometric efficiency are at least partially based on both the pinhole offset (i.e., the distance from a source to a pinhole aperture) and the focal length (i.e., the distance from a pinhole aperture to the detector assembly). For example, the image may be magnified if the pinhole offset is less than the focal length. In a similar manner, the image may be minified if the pinhole offset is greater than the focal length. The system resolution is based on the size of the pinhole aperture, the magnification, and the intrinsic detector resolution.

Furthermore, the quality of the image reconstruction is at least partially based on the degree of multiplexing (i.e. projection image overlap) on the gamma photon detector. More pinhole apertures may be placed in the collimator assembly to increase the geometric efficiency, but this may also increase the degree of multiplexing. If only multiplexed projections are available from a complex source distribution, then it is likely that the reconstructed image will contain aliasing artifacts, since the reconstruction algorithm cannot determine through which pinhole aperture a particular photon passed. In general, there must be at least some non-multiplexed portions of the projections to enable the image reconstruction algorithm to produce images without aliasing artifacts.

### SUMMARY

In accordance with one embodiment, the present invention provides an imaging system. The imaging system includes a collimator assembly having one or more apertures therein. The imaging system further includes a detector assembly configured to generate one or more signals in response to gamma photons that pass through the one or more apertures. The imaging system is configured so that two or more different spatial imaging resolutions and/or two or more different degrees of multiplexing are included in the projection data from which images are reconstructed.

In accordance with one embodiment, the present invention provides an imaging system. The imaging system includes a collimator assembly having one or more apertures therein. The imaging system further includes a detector assembly configured to generate one or more signals in response to gamma photons that pass through the one or more apertures. The imaging system is configured so that two or more different spatial imaging resolutions and/or two or more different degrees of multiplexing are included in the projection data from which images are reconstructed. The imaging system is further configured so that a pinhole collimator and a detector are arranged in a combined assembly, such that a pinhole-detector module can be moved with respect to the source.

In accordance with another embodiment, the present invention provides a method of changing collimator performance. The method includes exchanging the one or more pinhole apertures in the collimator assembly.

In accordance with another embodiment, the present invention provides a method of changing collimator performance. The method includes exchanging the mechanical assembly that combines a pinhole collimator and a detector into a pinhole-detector module for an assembly with a different focal length.

In accordance with another embodiment, the present invention provides a method of imaging a volume. The method includes positioning at least a portion of a subject in a field of view of a single photon emission computed tomography system. The method further includes collimating gamma photons emitted from the subject using one or more pinhole-detector modules. Each pinhole-detector module comprises a collimator having one or more pinhole apertures and a detector assembly. The method further includes detecting gamma photons that pass through the one or more pinhole apertures with the corresponding detector assembly. The method further includes generating one or more signals in response to the detected gamma photons. The method further includes selecting a mixture of pinhole-detector modules having two or more different spatial imaging resolutions and/or two or more different degrees of multiplexing.

According to an embodiment, an imaging system includes a collimator assembly having two or more apertures, and a detector assembly configured to generate two or more signals in response to gamma photons that pass through the two or more apertures. The collimator assembly and the detector assembly are configured to provide two or more different spatial imaging resolutions or two or more different degrees of multiplexing.

According to an embodiment, an imaging system includes first and second pinhole-detector modules arranged about an imaging volume. Each pinhole-detector module includes a collimator having one or more pinhole apertures therein, and a detector assembly configured to generate one or more signals in response to gamma photons that pass through the one or more pinhole apertures. The first pinhole-detector module has a first spatial imaging resolution, and the second pinhole-detector module has a second spatial imaging resolution different from the first spatial imaging resolution.

According to an embodiment, a method of imaging a subject in an imaging volume is provided. The method includes providing a single photon emission computed tomography imaging system with a collimator assembly and a detector assembly arranged about an imaging volume, placing a subject within the imaging volume, collimating gamma photons emitted from the subject through the collimator assembly, detecting the gamma photons with the detector assembly, and generating first and second signals in response to the detected gamma photons The first signal represents a first spatial imaging resolution of the detector assembly configured with the collimator assembly, and the second signal represents a second spatial imaging resolution of the detector assembly configured with the collimator assembly. The method also includes generating an image from the first and second signals.

According to an embodiment, a method of conducting single photon emission computed tomography imaging is provided. The method includes providing a first pinhole collimator and a first detector having a first focal length, providing a second pinhole collimator and a second detector having a second focal length different from the first focal length, focusing the first and second pinhole collimators based on a desired image resolution or sensitivity, and concurrently imaging a subject with the first and second pinhole collimators and detectors.

### DRAWINGS

These and other features, aspects, and advantages of the present invention will become better understood when the following detailed description is read with reference to the accompanying drawings in which like characters represent like parts throughout the drawings, wherein:

FIG. 1 is an illustration of an exemplary single photon emission computed tomography (SPECT) system which includes two or more collimator assemblies having at least two different focal lengths and/or at least two different degrees of multiplexing in accordance with embodiments of the present invention;

FIG. 2 is an illustration of a single pinhole aperture in accordance with embodiments of the present invention;

FIGS. 3-4 illustrate portions of pinhole-detector modules in accordance with embodiments of the present invention;

FIGS. 5-6 are detector projection views of exemplary pinhole-detector modules configured to have different focal lengths and different degrees of multiplexing in accordance with embodiments of the present invention; and

FIG. 7 is an illustration of a two-detector SPECT system configured to have two different spatial imaging resolutions in accordance with embodiments of the present invention.

FIG. 8 is a flowchart illustrating a method of imaging a subject in an imaging volume, according to an embodiment of the present invention.

### DETAILED DESCRIPTION

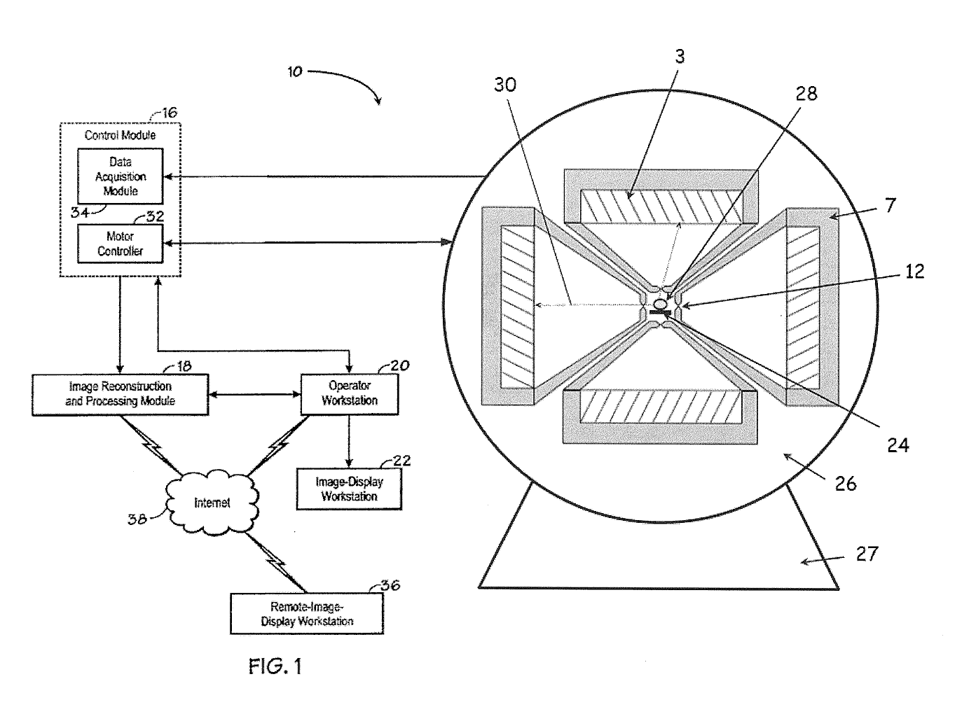

FIG. 1 illustrates an exemplary single photon emission computed tomography (SPECT) system 10 for acquiring and processing image data in accordance with exemplary embodiments of the present invention. As illustrated, the SPECT system 10 may include a collimator assembly 12 and a detector assembly 3. As will be discussed in more detail below, the focal length between one or more pinhole apertures in the collimator assembly 12 and the detector assembly 3 may be adjustable or may be fixed at a predetermined distance, for example, to provide a desired system resolution and sensitivity. In the illustrated embodiment, the SPECT system 10 also includes a control module 16, an image reconstruction and processing module 18, an operator workstation 20, and an image-display workstation 22. Each of the aforementioned components will be discussed in greater detail in the sections that follow.

As illustrated, a subject support 24 (e.g. a table) may be moved into position in a field of view of the SPECT system 10. In the illustrated embodiment, the subject support 24 is configured to support a subject 28 (e.g., a human patient, a small animal, a plant, a container, a porous object, etc.) having an imaging volume in a position for scanning. Alternatively, the subject support 24 may be stationary, while the SPECT system 10 may be moved into position around the subject 28 having the imaging volume for scanning. Those of ordinary skill in the art will appreciate that the subject 28 may be supported in any suitable position for scanning. By way of example, the subject 28 may be supported in the field of view in a substantially vertical position, a substantially horizontal position, or any other suitable position (e.g., inclined) for the desired scan. In SPECT imaging, the subject 28 is typically injected in a vein with a solution that contains a radioactive tracer. The solution is distributed and absorbed throughout the subject 28 in different degrees, depending on the tracer employed and, in the case of living subjects, the functioning of the organs and tissues. The radioactive tracer emits electromagnetic quanta (e.g., gamma photons), also known as “gamma rays” during a nuclear decay event, represented on FIG. 1 as gamma photons 30.

As previously mentioned, the SPECT system 10 includes collimator assembly 12 that collimates the gamma photons 30 emanating from the subject 28 positioned in the field of view. The collimator assembly 12 may be disposed between the detector assembly 3 and the subject 28 and may contain a shield 7 composed of radiation-absorbent material (or one or more radiation-absorbent panels), such as lead or tungsten, for example. In general, the collimator assembly 12 is configured to limit and define the direction and angular divergence of the gamma photons 30. In accordance with embodiments of the present invention, the collimator assembly 12 includes a pinhole collimator having one or more pinhole apertures therein. The shield 7 and collimator assembly 12 may be composed of the same material and may be continuous or constructed of overlapping pieces.

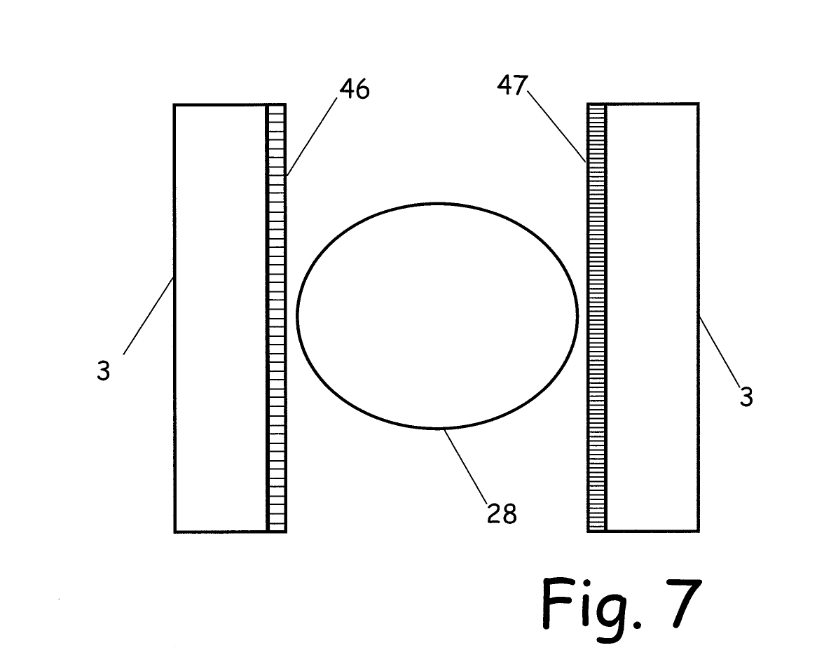

As will be discussed in more detail with respect to the following figures, at least two different focal lengths (i.e., the length between a pinhole aperture in the collimator assembly 12 and the detector assembly 3) of the pinhole apertures may be employed. This results in at least two different spatial resolutions and/or at least two different degrees of multiplexing for the projection images. In a SPECT system employing a plurality of detectors with other conventional collimator assemblies (i.e., parallel-hole, diverging-hole, converging-hole, slant-hole, etc.), the at least two different spatial resolutions may be accomplished, for example, by attaching a high-resolution collimator to at least one detector head and a high-sensitivity collimator to at least one different detector head (as shown in FIG. 7, described below). Alternatively, a hybrid collimator with regions producing at least two different spatial resolutions may be attached to a single detector head. In this manner, the system resolution and sensitivity may be modified without the need to swap collimator assemblies and acquire a second set of imaging data.

In one embodiment, the collimator assembly 12 (or collimator) having the one or more apertures therein and the detector assembly 3 are together referred to as a collimator-detector module, and two or more of the collimator-detector modules are configured to have two or more different spatial imaging resolutions and/or two or more different degrees of multiplexing. When the collimator is a pinhole aperture collimator, the collimator-detector module may be referred to as a pinhole-detector module. In other embodiments, other types of collimators include slit aperture collimators, parallel hole collimators, and converging and diverging collimators.

Referring again to FIG. 1, the collimator assembly 12 extends at least partially around the field of view containing at least part of the subject 28. In exemplary embodiments, multiple collimator assemblies 12 extend up to about 360° around the field of view. By way of example, multiple collimator assemblies 12 may extend from about 180° to about 360° around the subject. In certain embodiments, one or more pinhole-collimator units are positioned around the field of view, with each pinhole-collimator unit having one or more pinhole apertures therein.

The gamma photons 30 that pass through the pinhole apertures in the collimator assembly 12 impact the detector assembly 3. Due to the collimation of the gamma photons 30 by the collimator assembly 12, the detection of the gamma photons 30 may be used to determine the line of response along which each of the gamma photons 30 traveled before reaching, impacting, and interacting inside the detector assembly 3, allowing localization of each gamma photon's origin to that line. In general, the detector assembly 3 may include a plurality of detector elements configured to detect the gamma photons 30 emanating from the subject 28 in the field of view and passing through one or more pinhole apertures through the collimator assembly 12. In exemplary embodiments, each detector element produces an electrical signal in response to the impact of the gamma photons 30.

As will be appreciated by those of ordinary skill in the art, the detector elements of the detector assembly 3 may include any of a variety of suitable materials and/or circuits for detecting the impact and interaction of the gamma photons 30. By way of example, the detector elements may include a plurality of solid-state detector elements, which may be provided as one-dimensional or two-dimensional arrays. In another embodiment, the detector elements of the detector assembly 3 include a scintillation assembly and PMTs or other light sensors.

Moreover, the detector elements may be arranged in the detector assembly 3 in any suitable manner. By way of example, multiple detector assemblies 3 may extend at least partially around the field of view. In certain embodiments, the multiple detector assemblies 3 include modular-detector elements arranged around the field of view. Alternatively, the detector assemblies 3 may be arranged in a ring that may extend up to about 360° around the field of view. In certain exemplary embodiments, the multiple detector assemblies 3 extend from about 180° to about 360° around the field of view. The ring of detector elements may include flat panels or curved detector surfaces (e.g., a NaI annulus). In one exemplary embodiment, the ring includes in the range from 8-50 solid-state detector modules. Those of ordinary skill in the art will appreciate that the ring need not be circular, for example, the detector elements may be arranged in an elliptical ring or be contoured to the body profile of the subject 28. In addition, in certain exemplary embodiments, the detector assembly 3 is gimbaled on its support base, e.g., so that suitable arbitrary slice angles can be acquired.

In another exemplary embodiment, a ring of solid-state detectors is deployed within the magnetic field of an MRI system. The collimator assembly may be integrated with the RF transmit/receive coil (e.g., the collimator assembly is integrally provided with the RF transmit/receive coil). Also, the SPECT and MR images may be acquired sequentially or simultaneously.

In another exemplary embodiment as shown in FIG. 1, the detector assemblies 3 are each comprised of up to four detector heads, each comprised of a two-dimensional array of 5×5 modules. The detector heads are mechanically coupled to the corresponding collimator assemblies to form collimator-detector modules, and the collimator-detector modules are supported by a gantry rotor 26. In one embodiment the gantry rotor is a flat circular disc supported in a vertical position, as shown in FIG. 1. This disc may be formed from a metal plate that is a few centimeters in thickness. The disc 26 has an opening in the center to allow passage of the support 24 and subject 28. The gantry rotor 26 may be configured to rotate about a horizontal axis to various angular positions so that the collimator-detector assemblies may view the subject 28 from various angles. Further, the collimator-detector assemblies may be enabled to move radially, azimuthally, and/or directionally on the gantry rotor 26. The gantry rotor 26 may be supported by a gantry base (stator) 27 that may be stationary with respect to the room or may be mobile and enabled to move.

To acquire multiple lines of response emanating from the subject 28 in the field of view during a scan, the collimator assembly 12 may be configured to rotate about the subject 28 positioned within the field of view. In accordance with exemplary embodiments, the collimator assembly 12 is configured to rotate with respect to the detector assembly 3. By way of example, the detector assembly 3 may be stationary while the collimator assembly 12 may be configured to rotate about the field of view. Alternatively, the detector assembly 3 may rotate while the collimator assembly 12 is stationary. In certain exemplary embodiments, the collimator assembly 12 and the detector assembly 3 are both configured to rotate, either together or independent of one another. Alternatively, if sufficient pinhole apertures are provided in the collimator assembly 12, then no rotation may be required for image reconstruction.

As illustrated, SPECT system 10 further includes a control module 16. In the illustrated embodiment, the control module 16 includes one or more motor controllers 32 and a data-acquisition module 34. In general, the motor controller 32 may control the rotational speed and position of the detector assembly 3, the collimator assembly 12, and/or the position of the subject support 24. In addition, the motor controllers 32 may control position and orientation of individual detectors 3 which may move independently or in combination with sections of the collimator assembly 12. The data-acquisition module 34 may be configured to obtain the signals generated in response to the impact of the gamma photons 30 with the detector assembly 3. For example, the data-acquisition module 34 may receive sampled electrical signals from the detector assembly 3 and convert the data to digital signals for subsequent processing by the image reconstruction and processing module 18. Alternatively, the detector module 3 may directly generate digital signals that are transmitted to the data-acquisition module 34.

Those of ordinary skill in the art will appreciate that any suitable technique for data acquisition may be used with the SPECT system 10. By way of example, the data needed for image reconstruction may be acquired in a list or a frame mode. In one exemplary embodiment of the present invention, gamma photon events (e.g., the impact of gamma photons 30 on the detector assembly 3), gantry 26 motion (e.g., collimator assembly 12 motion, detector assembly 3 position, and subject support 24 position), and physiological signals (e.g., heart beat and respiration) are acquired in a list mode. List mode is suitable in exemplary embodiments where the count rate is relatively low and many pixels record no counts at each gantry position or physiological gate. Alternatively, frames and physiological gates may be acquired by moving the gantry in a step-and-shoot manner and storing the number of events in each pixel during each frame time and heart or respiration cycle phase. Frame mode may be suitable, for example, where the count rate is relatively high and most pixels are recording counts at each gantry position or physiological gate.

In the illustrated embodiment, the image reconstruction and processing module 18 is coupled to the data-acquisition module 34. The signals acquired by the data-acquisition module 34 may be provided to the image reconstruction and processing module 18 for image reconstruction. The image reconstruction and processing module 18 may include electronic circuitry to receive acquired signals, and electronic circuitry to condition the acquired signals received from the data-acquisition module 34. Further, the image reconstruction and processing module 18 may include processing to coordinate functions of the SPECT system 10 and implement reconstruction algorithms suitable for reconstruction of the acquired signals. The image reconstruction and processing module 18 may include a digital-signal processor, memory, a central-processing unit (CPU) or the like, for processing the acquired signals. As will be appreciated, the processing may include the use of one or more computers. The addition of a separate CPU may provide additional functions for image reconstruction, including, but not limited to, signal processing of data received, and transmission of data to the operator workstation 20 and image display workstation 22. In one embodiment, the CPU is confined within the image reconstruction and processing module 18, while in another embodiment a CPU includes a stand-alone device that is separate from the image reconstruction and processing module 18.

The reconstructed image may be provided to the operator workstation 20. The operator workstation 20 may be utilized by a system operator to provide control instructions to some or all of the described components and for configuring the various operating parameters that aid in data acquisition and image generation. An image display workstation 22 coupled to the operator workstation 20 may be utilized to observe the reconstructed image. It should be further noted that the operator workstation 20 and the image-display workstation 22 may be coupled to other output devices, which may include printers and standard or special purpose computer monitors. In general, displays, printers, workstations and similar devices supplied with the SPECT system 10 may be local to the data-acquisition components, or may be remote from these components, such as elsewhere within the institution or hospital, or in an entirely different location, linked to the image acquisition system via one or more configurable networks, such as the Internet, virtual private networks, and so forth. By way of example, the operator workstation 20 and/or the image reconstruction and processing module 18 may be coupled to a remote-image display workstation 36 via a network (represented on FIG. 1 as Internet 38).

Furthermore, those of ordinary skill in the art will appreciate that any suitable technique for image reconstruction may be used with the SPECT system 10. In one exemplary embodiment, iterative reconstruction (e.g., ordered subsets expectation maximization, OSEM) is used. Iterative reconstruction may be suitable for certain implementations of the SPECT system 10 due, for example, to its speed and the ability to tradeoff reconstruction resolution and noise by varying the convergence and number of iterations.

While in the illustrated embodiment, the control module 16 (including the data-acquisition module 34 and the motor controller 32) and the image reconstruction and processing module 18 are shown as being outside the detector assembly 3 and the operator workstation 20. In certain other implementations, some or all of these components are provided as part of the detector assembly 3, the operator workstation 20, and/or other components of the SPECT system 10.

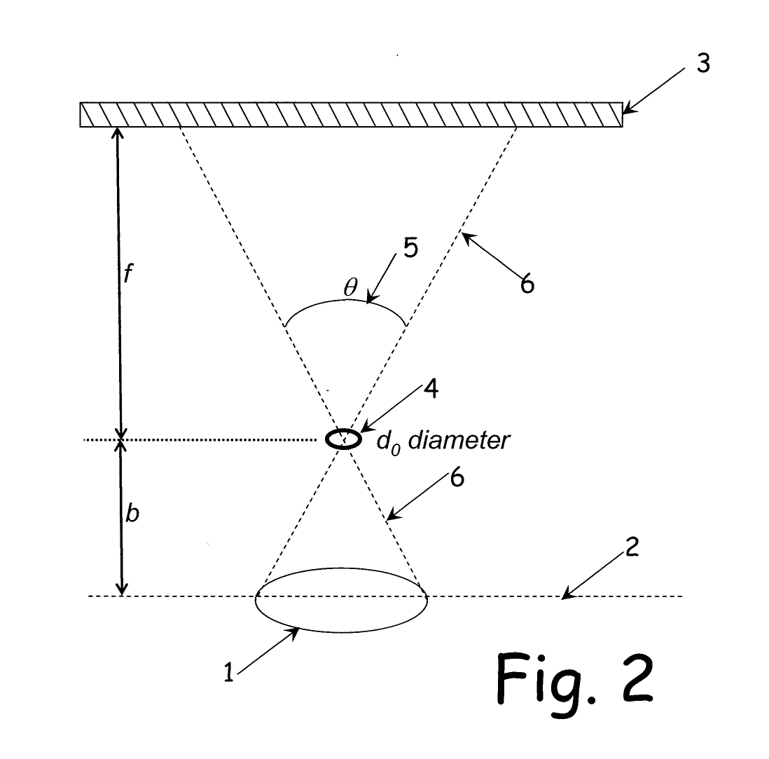

Referring now to FIG. 2, a view of one pinhole aperture 4 in the collimator assembly 12 is illustrated. The circular cross-section 1 represents the field of view of the one pinhole aperture 4. The field of view 1 is shown centered on a system axis of rotation 2. It will be understood that the detector assembly 3 and/or the collimator assembly 12 may rotate or move in a complex fashion about the axis of rotation 2, or in exemplary embodiments they can remain stationary. One circular pinhole aperture 4 is illustrated and gamma photons are allowed to pass through the pinhole aperture 4 and impact the detector 3.

By way of illustration, two exemplary lines of response 6 are shown connecting the field-of-view 1 to the detector 3 through the pinhole aperture 4. These limiting lines of response 6 define an opening angle 5. It will be understood that a pinhole aperture is generally a three-dimensional opening in an attenuating plate or cylinder, for example, which stops gamma photons that do not pass through a pinhole aperture 4. The three-dimensional shape of the aperture physically defines the opening angle. It will be appreciated by those of ordinary skill in the art that the cross-section of the pinhole aperture 4 may be circular or elliptical or polygonal and that the narrowest portion of the pinhole aperture may have a knife-edge or a keel-edge or a rounded edge. Each choice of shape and edge of the pinhole aperture 4 will affect the gamma photon projections and, hence, the resolution and geometric efficiency. If the image reconstruction faithfully represents the physics of gamma photon transmission and scatter through the pinhole aperture, then a faithful image can be formed from the projected data.

The geometric efficiency of a number N of pinhole apertures identical to the one illustrated in FIG. 2 can be described by a simple equation as

G=N d² cos³⁽θ/2)/(4 b²), Eqn. [1]

where G is the geometrical efficiency in dimensionless units, N is the number of pinhole apertures 4, d is the effective diameter of the circular pinhole apertures 4, θ is the opening angle 5, and b is the distance from the subject (or the axis-of-rotation, as a representative fiducial) to the pinhole aperture 4. In a system that rotates about the axis of rotation 2 of FIG. 2, the distance b is also called the radius of rotation. Those with ordinary skill in the art will appreciate that this simple geometrical equation may be modified to represent different pinhole aperture shapes. Furthermore, the effective diameter d of the circular pinhole with a knife edge may be approximated as:

d=d₀+tan(θ/2) ln(2)/μ, Eqn. [2]

where d₀ is the nominal diameter and μ is the linear attenuation coefficient of the collimator material (e.g., tungsten, lead, tantalum, gold, etc.) for gamma photons of the photopeak energy being imaged. The term ln(2)/μ will be recognized as the mean free path for gamma photons. It will be appreciated that the addition to the nominal diameter represents penetration of the knife edge by a portion of the gamma photons striking the region near the edge of the pinhole aperture 4.

With regard to Eqn. [1], it will be appreciated that the geometric efficiency G may be increased by modifying one or more parameters, including increasing the number of pinholes N, increasing the effective diameter of the pinholes d, increasing the opening angle θ, and/or decreasing the source-collimator distance b.

The system resolution of a pinhole aperture as illustrated in FIG. 2 can be described by several equations:

R_{det}=p/M, Eqn. [3]

where R_{det} is the resolution due to the size of detector pixels p and the pinhole collimator magnification M:

M=f/b, Eqn. [4]

where the focal distance f is the distance between the pinhole and the detector and b, as above, is the source-collimator distance. The second component of resolution R_{PH} depends upon the effective pinhole aperture 4:

R_{PH}=d (1+1/M). Eqn. [5]

The system resolution R_{sys} is a quadrature sum of the detector and pinhole resolutions:

R_{sys} =\sqrt{R_{det}²+R_{PH}²}. Eqn. [6]

It will be apparent to those of ordinary skill in the art that geometric efficiency, system resolution, and field-of-view can be traded off by varying one or more of the system design parameters (N, d, b, f p, θ, μ). This invention goes beyond the conventional trade-off choices that result in task-specific collimator designs (e.g., high resolution or general purpose or high sensitivity). This invention mixes together collimator assemblies 12 and detector assemblies 3 with two or more different spatial imaging resolutions and/or two or more different degrees of multiplexing, resulting in an image featuring both the highest resolution and a higher geometric efficiency. It should be understood that to obtain an image featuring this high resolution and high geometric efficiency, sufficient spatial sampling of the subject should be acquired with both the high resolution and high sensitivity components. Sufficient sampling will depend on the particular subject, the dose given, the duration of imaging, the imaging task, and other variables, in order to acquire sufficient counts to create an image.

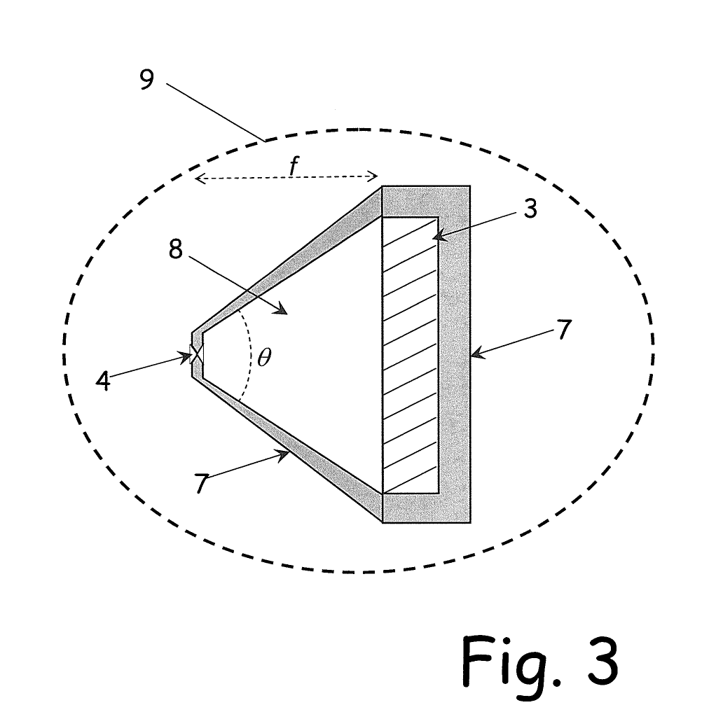

Refer now to FIG. 3 which illustrates a pinhole-detector module 9 in accordance with a preferred embodiment of the present invention. The gamma photon detector 3 is mechanically combined with a pinhole collimator 4 at an adjustable or at a predetermined and fixed focal distance f (pinhole to detector distance. A single pinhole aperture 4 is illustrated, but it will be appreciated that a plurality of pinhole apertures may be placed in the collimator assembly. The detector 3 is surrounded by a shield 7 that blocks or prevents gamma photons from striking the detector unless they pass through the pinhole aperture 4. The space 8 between the pinhole aperture 4 and the detector 3 is generally filled only with air to avoid attenuation and scattering of gamma photons after they have passed through the pinhole collimator 4. However, there may be circumstances in which it is desirable to partially fill space 8 with a low-density material, such as foam, to add mechanical support.

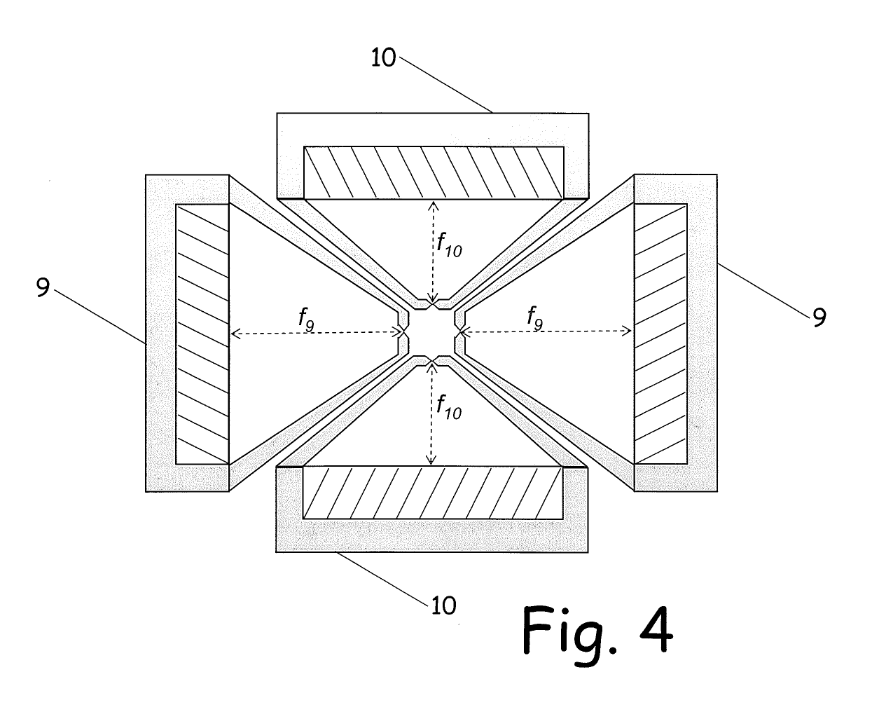

FIG. 4 shows a schematic illustration of a portion of a SPECT system including (or consisting of) four pinhole-detector modules 9 and 10, in which the focal length of the two oppositely positioned pinhole-detector modules 10 is shorter than the focal length of the pair of pinhole-detector modules 9. In one embodiment, the SPECT system is the Gamma Medica Triumph® SPECT system for small animal pre-clinical imaging research (Gamma Medica, Inc., Northridge, Calif.). This system is used for SPECT imaging of small animals such as mice, rats, and rabbits. The four detectors 3 each consist of a 5×5 array of solid-state CZT detector modules. The pinhole apertures 4 consist of a plate of tungsten with typically 5, 7, or 9 pinholes. The remaining gamma photon shield 7 is typically made from lead, which is considerably less costly than tungsten. In a preferred embodiment, the focal length for the pinhole-detector module pair 9 is fixed at about 90 mm (as also shown in FIG. 1) and the focal length for pair 10 is fixed at about 50 mm. The geometry of the four detectors 3 and their square-pyramid shaped shields 7 allows the modules 9 and 10 to reach a minimum radius of rotation b (source-pinhole distance) of 25 mm. At this minimum b the magnification M is 2.0 for the pinhole-detector module pair 10 and M is 3.6 for the pinhole-detector module pair 9.

It will be appreciated that for the configuration of FIG. 4 with two different opposed pairs of pinhole-detector modules 9 and 10, that a complete SPECT acquisition generally requires sampling over a range of 180 degrees. In some circumstances this requirement can be relaxed and a sampling of views over a range of only 90 degrees can produce good image reconstruction. However, in the experience of the present inventive entity, it is better to reduce acquisition time by sampling azimuthal angular views more coarsely while keeping the full 180 degree range, rather than to shorten the range and keep a finer angular sampling increment. For example, if a standard imaging protocol uses 6 degree increments, then 30 angular views would be required. When using statistical image reconstruction with full physics modeling of collimator-detector response, it is often possible to reduce sampling by a factor of 2. It would be better to use a 1/2-time (15 angular views) protocol with 12 degree view increments over a 180 degree range, rather than with 6 degree increments over a 90 degree range. It should be understood that this image acquisition involves simultaneously or concurrently acquiring data from both pairs of pinhole-detector modules 9 and 10, so that the different signals generated from these two different pinhole-detector modules are acquired at the same time from the subject. The system is then rotated and additional data is acquired, through 90 or 180 degrees as noted above.

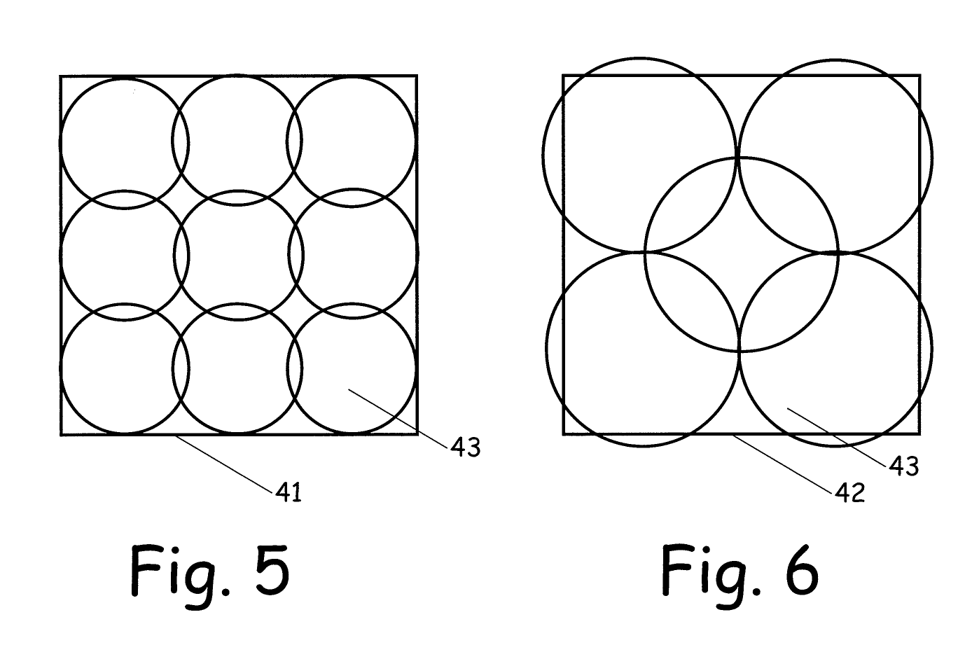

Continuing with the discussion of the preferred embodiment, consider FIGS. 5 and 6, illustrating detector projection views of exemplary pinhole-detector modules, such as those illustrated in FIG. 4. These projections 43 show the pattern of gamma photons that strike the detector 3 after passing through multiple pinhole apertures 4. The large squares 41 and 42 in both FIGS. 5 and 6 represent the detector 3 surface area, which in the preferred embodiment consists of a 5×5 CZT module array. The circles 43 in both FIGS. 5 and 6 represent the outlines of the projections through multiple pinholes 4 of a large flood source of gamma photons. The circles 43 would be filled with recorded gamma photon events and each would have a domed intensity pattern with more events counted near the centers of the circles and fewer events recorded near the circumference of the circles.

Those with ordinary skill in the art will appreciate that only the central circular pinhole aperture 4, which has a central line of response 6 that is normally incident on the detector 3, will project a circle. The peripheral circular pinhole apertures 4, which have central lines of response 6 that are obliquely incident on the detector 3, will actually project ellipses. For simplicity of this particular illustration, circles 43 have been used. FIG. 5 illustrates the projections 43 from nine pinhole apertures 4, corresponding to pinhole-detector modules 10 in FIG. 4 with a shorter focal length f and smaller magnification M. FIG. 6 illustrates the projections 43 from five pinhole apertures 4, corresponding to pinhole-detector modules 9 in FIGS. 3 and 4 with a longer focal length f and larger magnification M. The size of the projections 43 scales in each of two dimensions with magnification M. In FIG. 5 the projections 43 from a shorter focal length pinhole-detector module 10 have minimal overlap (multiplexing), lower resolution (larger R_{sys}, Eqns [3]-[6]), and higher geometric efficiency (larger N, Eqns. [1]-[2]). In FIG. 6 the projections 43 from a longer focal length pinhole-detector module 9 have substantial overlap (multiplexing), higher resolution (smaller R_{sys}, Eqns [3]-[6]), and lower geometric efficiency (smaller N, Eqns. [1]-[2]).

It will be appreciated by those skilled in the art that the projection patterns shown in FIGS. 5 and 6 may be associated with reconstructed image artifacts due to the axial sampling pattern. These artifacts can be greatly reduced by rotating the pinhole pattern with respect to the axis of the normally-incident line of response (that strikes the center of detector surface 41 or 42), to more evenly distribute the projections in the axial direction.

Statistical image reconstruction, such as ML-EM (maximum-likelihood expectation-maximization) or OSEM (ordered subset expectation maximization), with full physics modeling of the pinhole collimators and detectors enables accurate image reconstruction of the data acquired by the system illustrated in FIG. 4 which mixes two different spatial imaging resolutions and two different degrees of multiplexing. The resulting images have the higher resolution contributed by the pinhole-detector module pair 9 with the longer focal length f and the higher geometric efficiency contributed more by the pinhole-detector module pair 10 with the shorter focal length f This resulting image can be obtained without the need to re-image the subject a second time with a second collimator assembly. In the embodiment of FIG. 4, the two sets of data from the two different modules 9 and 10 are taken simultaneously or concurrently from the subject, so that the resulting combined image can be generated. A reconstructed image with both good resolution and good sensitivity can be obtained from a single imaging session.

In another exemplary embodiment of this invention, the collimator assembly 12 consists of multiple pinhole apertures with a mixture of two or more different aperture sizes, and thus, two or more different spatial resolutions and efficiencies. If the number of higher-resolution/lower efficiency pinhole apertures is approximately or substantially the same as the number of lower-resolution/higher-efficiency pinhole apertures, then the reconstructed image resolution can be predominantly determined by the higher-resolution apertures and the system efficiency (and contrast) can be significantly increased by the higher-efficiency apertures. In one embodiment, the number of higher-resolution/lower efficiency pinhole apertures is the same as the number of lower-resolution/higher-efficiency pinhole apertures. In other embodiments the number of higher-resolution/lower efficiency pinhole apertures and the number of lower-resolution/higher-efficiency pinhole apertures are substantially the same, within about a factor of 2. In other embodiments, the numbers may differ within about a factor of 3, or up to a factor of 5.

In another exemplary embodiment of this invention, the mixing of two different degrees of multiplexing is achieved in time rather than in space. That is, the two data sets are acquired sequentially rather than simultaneously. In particular, during a portion of the acquisition time highly multiplexed projection data is acquired and during the remainder of the acquisition time only minimally multiplexed projection data is acquired. This reduction in multiplexing may be achieved mechanically by covering a portion of the pinhole apertures, thus decreasing both the degree of multiplexing and the system efficiency in order to provide the minimally-multiplexed portion of the data required for non-aliased image reconstruction.

In another exemplary embodiment of this invention, the mixing of two or more different spatial resolutions is achieved by adjusting the pinhole aperture sizes during the acquisition. In particular, during a portion of the acquisition time projections with a first characteristic resolution are acquired, then the pinhole aperture sizes are adjusted and the remainder of the projections is acquired. This change in aperture size may be achieved by using mechanically adjustable pinhole apertures, as taught in U.S. Pat. Nos. 7,723,690 and 7,439,514, which are incorporated by reference in their entity and attached herewith. Alternatively, the collimator assembly 12 may be fabricated with two or more pinhole aperture sizes and may be provided with a shutter mechanism that can alternately expose the first group and cover the second group of the apertures and then, in the midst of the acquisition time the shutter can be moved to expose the second group and cover the first group of the apertures.

In another exemplary embodiment of the invention, the mixing of two or more different spatial resolutions and two or more different degrees of multiplexing is achieved by moving the collimator assembly 12 and/or the detector assembly 3 after a portion of the acquisition time such that the magnification M (Eqn. [4]) is adjusted. This may be accomplished in the system of FIG. 4 by with a radial movement (“zooming in/out”) of the pinhole-detector modules. Alternatively, this may be accomplished by adjustable focal length collimators, as taught by U.S. Pat. No. 7,671,340, which is incorporated by reference and attached herewith.

Refer now to FIG. 7 which illustrates a two-detector SPECT system configured to have two different spatial imaging resolutions in accordance with another embodiment of the invention. The subject 28 is shown with two parallel-hole collimator-detector modules in close proximity to optimize system resolution. The two collimators have different resolution-efficiency performance, so the system is another exemplary embodiment of the principle of this invention—namely to mix two or more different resolutions and/or degrees of multiplexing. The embodiment in FIG. 7 illustrates the mixing of two different resolutions. For example, collimator 46 represents a high-sensitivity parallel-hole collimator, typically fabricated with larger holes and/or shorter septa, while collimator 47 represents a high-resolution parallel-hole collimator, typically fabricated with smaller holes and/or longer septa. It will be apparent to one of ordinary skill in the art that, depending on the imaging task, collimators 46 and 47 could be diverging-hole, converging-hole, or slant-hole designs of two different resolution-efficiency performance characteristics.

In view of the above and according to one embodiment, the collimator assembly and the detector assembly are configured to have two or more different magnifications to achieve a mixture of two or more different spatial imaging resolutions and/or two or more different degrees of multiplexing.

In one embodiment, the collimator assembly is configured to adjust the number of open apertures to achieve a mixture of two or more different degrees of multiplexing.

In one embodiment, the collimator assembly is configured to adjust the size of open apertures to achieve a mixture of two or more different spatial imaging resolutions.

In one embodiment, the collimator assembly and/or the detector assembly are/is configured to move to achieve a mixture of two or more different spatial imaging resolutions and/or two or more different degrees of multiplexing.

In one embodiment, two or more different focal lengths between a detector assembly and a pinhole collimator assembly are predetermined and fixed in a plurality of pinhole-detector modules. Here, the two or more different focal lengths may be predetermined based on image magnification and/or minification, or the two or more different focal lengths may be predetermined based on use of detector area for the pinhole apertures of the pinhole collimator, or the two or more different focal lengths may be predetermined based on size of an image field of view.

When the mixed resolution-efficiency projection data is reconstructed, the higher-resolution/lower-efficiency collimator will predominantly determine the reconstructed system resolution and the additional event counts provided by the higher-efficiency/lower-resolution collimator will improve the image contrast and, hence, the detectability of small features or small lesions. As noted before, the projection data for this mixed collimator pair should be acquired over a 180 degree range. If a 1/2-time acquisition is desired, the angular view sampling interval should be doubled and the 180 degree range should be maintained.

It will be appreciated by those skilled in the art that many alternative approaches may be taken to reconstruct images using the mixed resolution/multiplexing data. By way of illustration, one successful approach consists of statistical iterative image reconstruction using an ML-EM or OSEM approach. The lower resolution, minimally multiplexed (lower magnification) projection data subsets may be reconstructed first to form a lower resolution image. Then the data from the higher resolution, more multiplexed (higher magnification) projection data subsets may be added to the iterative reconstruction, using the lower resolution image as a starting point. In the experience of the inventive entity, this approach yields a final reconstructed image that combines the high spatial resolution of the higher magnification projections and the higher efficiency enabled by the lower magnification projections.

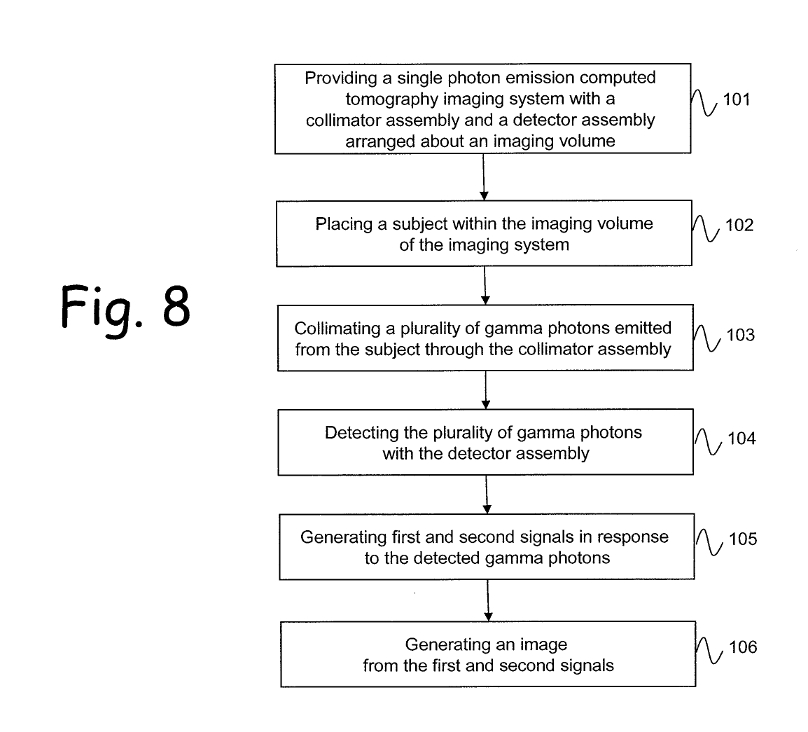

According to an embodiment, a method of imaging a subject is provided, as shown for example in FIG. 8. The method includes providing a single photon emission computed tomography imaging system 101. The imaging system is provided with a collimator assembly and a detector assembly arranged about an imaging volume. The method also includes placing a subject within the imaging volume of the imaging system 102, collimating a plurality of gamma photons emitted from the subject through the collimator assembly 103, and detecting the plurality of gamma photons with the detector assembly 104. The method also includes generating first and second signals in response to the detected gamma photons 105. In one embodiment, the first signal represents a first spatial imaging resolution and/or degree of projection multiplexing of the detector assembly configured with the collimator assembly, and the second signal represents a second spatial imaging resolution and/or degree of projection multiplexing of the detector assembly configured with the collimator assembly. The method also includes generating an image from the first and second signals 106. This may include utilizing statistical iterative image reconstruction to reconstruct the image from the first and second signals. In one embodiment, the statistical iterative image reconstruction includes reconstructing an initial lower resolution and/or less multiplexed image from the first signal and adding data to the image from the second signal.

While only certain features of the invention have been illustrated and described herein, many modifications and changes will occur to those skilled in the art. It is, therefore, to be understood that the following claims are intended to cover all such modifications and changes as fall within the true spirit of the invention.

1. An imaging system, comprising:
a collimator assembly having two or more apertures; and
a detector assembly configured to generate two or more signals in response to gamma photons that pass through the two or more apertures,
wherein the collimator assembly and the detector assembly are configured to provide two or more different spatial imaging resolutions or two or more different degrees of multiplexing.

2. The imaging system of claim 1, wherein the collimator assembly and the detector assembly are configured to provide two or more different spatial imaging resolutions and two or more different degrees of multiplexing.

3. The imaging system of claim 1, wherein the detector assembly comprises first and second detector heads, and wherein the collimator assembly comprises a first high resolution collimator and a second high sensitivity collimator, and wherein the first detector head is coupled to the first high resolution collimator, and the second detector head is coupled to the second high sensitivity collimator.

4. The imaging system of claim 1, wherein the collimator assembly is configured to have two or more different aperture sizes to achieve the two or more different spatial imaging resolutions or the two or more different degrees of multiplexing.

5. The imaging system of claim 1, wherein the collimator assembly and the detector assembly are configured to provide two or more different degrees of multiplexing, and wherein the collimator assembly is configured to adjust the number of open apertures of the two or more apertures to achieve the two or more different degrees of multiplexing.

6. The imaging system of claim 1, wherein the collimator assembly and the detector assembly are configured to provide two or more different spatial imaging resolutions, and wherein the collimator assembly is configured to adjust the size of open apertures of the two or more apertures to achieve the two or more different spatial imaging resolutions.

7. The imaging system of claim 1, wherein the collimator assembly and the detector assembly are movable with respect to each other to achieve the two or more different spatial imaging resolutions or the two or more different degrees of multiplexing.

8. The imaging system of claim 1, wherein the collimator assembly and the detector assembly are configured to have two or more different spatial imaging resolutions.

9. The imaging system of claim 1, further comprising:
an image reconstruction and processing module configured to receive the two or more signals and to process the two or more signals to generate one or more images;
an image display workstation configured to display the one or more images; and
a subject support for supporting a subject in a field of view of the collimator assembly.

10. The imaging system of claim 1, wherein the collimator assembly and the detector assembly comprise a first collimator-detector module having a first spatial imaging resolution, and a second collimator-detector module having a second spatial imaging resolution.

11. The imaging system of claim 10, wherein the first collimator-detector module comprises a first focal length, and the second collimator-detector module comprises a second focal length different from the first focal length.

12. The imaging system of claim 11, wherein the first collimator-detector module and the second collimator-detector module are mounted angularly apart from each other about an imaging volume.

13. The imaging system of claim 11, further comprising third and fourth collimator-detector modules having respective third and fourth focal lengths, the third collimator-detector module being mounted opposite an imaging volume from the first collimator-detector module, and the fourth collimator-detector module being mounted opposite the imaging volume from the second collimator-detector module.

14. The imaging system of claim 13, wherein the third focal length is the same as the first focal length, and the fourth focal length is the same as the second focal length.

15. The imaging system of claim 1, wherein the collimator assembly and the detector assembly are configured to have two or more different magnifications to achieve the two or more different spatial imaging resolutions or the two or more different degrees of multiplexing.

16. An imaging system, comprising:
first and second pinhole-detector modules arranged about an imaging volume, each pinhole-detector module comprising:
a collimator having one or more pinhole apertures therein; and
a detector assembly configured to generate one or more signals in response to gamma photons that pass through the one or more pinhole apertures,
wherein the first pinhole-detector module has a first spatial imaging resolution, and the second pinhole-detector module has a second spatial imaging resolution different from the first spatial imaging resolution.

17. The imaging system of claim 16, wherein the first pinhole-detector module has a first magnification, and the second pinhole-detector module has a second magnification different from the first magnification.

18. The imaging system of claim 16, wherein the first pinhole-detector module has a first aperture size, and the second pinhole-detector module has a second aperture size different from the first aperture size.

19. The imaging system of claim 16, wherein the first and second pinhole-detector modules are movable with respect to the imaging volume, independently from each other.

20. The imaging system of claim 16, wherein each pinhole-detector module comprises a plurality of radiation-absorbent panels connecting the collimator and the detector assembly.

21. A method of imaging a subject in an imaging volume, the method comprising:
providing a single photon emission computed tomography imaging system with a collimator assembly and a detector assembly arranged about an imaging volume,
placing a subject within the imaging volume of the imaging system;
collimating a plurality of gamma photons emitted from the subject through the collimator assembly;
detecting the plurality of gamma photons with the detector assembly;
generating first and second signals in response to the detected gamma photons, the first signal representing a first spatial imaging resolution of the detector assembly configured with the collimator assembly and the second signal representing a second spatial imaging resolution of the detector assembly configured with the collimator assembly; and
generating an image from the first and second signals.

22. The method of claim 21, wherein generating the first and second signals is done sequentially.

23. The method of claim 22, wherein sequentially generating the first and second signals comprises collimating and detecting a first plurality of gamma photons through a first set of apertures in the collimator assembly and subsequently collimating and detecting a second plurality of gamma photons through a second set of apertures in the collimator assembly, the second set of apertures differing in configuration from the first set of apertures.

24. The method of claim 23, further comprising switching between the first set of apertures and the second set of apertures by adjusting a size, shape, or number of open apertures.

25. The method of claim 21, wherein generating the first and second signals is done concurrently.

26. The method of claim 25, wherein concurrently generating the first and second signals comprises collimating and detecting a first plurality of gamma photons through a first set of apertures in the collimator assembly and concurrently collimating and detecting a second plurality of gamma photons through a second set of apertures in the collimator assembly, the second set of apertures differing in configuration from the first set of apertures.

27. The method of claim 25, wherein concurrently generating the first and second signals comprises collimating and detecting a first plurality of gamma photons through a first collimator-detector module having a first focal length and concurrently collimating and detecting a second plurality of gamma photons through a second collimator-detector module having a second focal length.

28. The method of claim 27, further comprising rotating the first and second collimator-detector modules about the subject.

29. The method of claim 28, further comprising rotating the first and second collimator-detector modules about the subject through at least 180 degrees.

30. The method of claim 21, wherein the generating of the image comprises utilizing statistical iterative image reconstruction to reconstruct the image from the first and second signals.

31. The method of claim 30, wherein the statistical iterative image reconstruction comprises reconstructing an initial lower resolution image from the first signal and adding data to the image from the second signal.

32. A method of conducting single photon emission computed tomography imaging, comprising:
providing a first pinhole collimator and a first detector having a first focal length;
providing a second pinhole collimator and a second detector having a second focal length different from the first focal length;
focusing the first and second pinhole collimators based on a desired image resolution or sensitivity; and
concurrently imaging a subject with the first and second pinhole collimators and detectors.
